(19) United States
(12) Patent Application Publication
(10) Pub. No.: US 2006/0271494 A1
(43) Pub. Date: Nov. 30, 2006

(54) Apparatus, method and computer program product for reusing digital content according to license information

(75) Inventor: Satoshi Ito, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/352,306

(22) Filed: Feb. 13, 2006

(30) Foreign Application Priority Data
May 25, 2005 (JP) 2005-152988

(51) Int. Cl. G06Q 99/00

(52) U.S. Cl. 705/59

(57) ABSTRACT

A digital content editing apparatus includes a reuse license processor configured to obtain from license information of content, rights expression of reuse operation including such consumable quoting conditions that does not make quoted content take over the license information. The quoted content is content created through quoting from an original content which is a composite or single content having the license information with the rights expression of reuse operation defined. The apparatus also includes an operational instruction creating unit configured to create an operational instruction for reusing the content according to the rights expression of reuse operation; a material reusing unit configured to reuse the content according to the operational instruction; a license information creating unit configured to create license information with the consumable quoting conditions deleted from the license information of the quoting content, as the license information of the quoted content; and an edit unit configured to edit the content.

### CROSS-REFERENCE TO RELATED APPLICATIONS

This application is based upon and claims the benefit of priority from the prior Japanese Patent Application No. 2005-152988, filed on May 25, 2005; the entire contents of which are incorporated herein by reference.

### BACKGROUND OF THE INVENTION

1. Field of the Invention

The invention relates to a digital content editing apparatus, a digital content editing method, and a computer program product for reusing digital content according to license information including rights expression for a reuse operation.

2. Description of the Related Art

These days, a lot of digital rights management (DRM) techniques for protecting of digital copyrighted works are developed. Strong protection for copyrights of commercial digital content such as movies and music, as represented by a DVD, has been increased in favour of content providers.

The copyright protection function in these techniques provides an extremely rigid and tough mechanism and it constrains user's degree of freedom much more than that of analog content because there is a strong need for prohibiting copying of digital content.

Although copyright laws include a fair use definition in which copying or quoting of copyrighted works for a private use is allowed without permission of the copyright holder, a user's degree of freedom to use the digital copyrighted works is constraint in order to prohibit copying as mentioned above and no copying nor quoting of them is permitted even for a private use, hence there increases a demand for a fair use of the digital copyrighted works.

While, little attention is paid to the copyright documents, production catalogues, private websites, electronic mails, and so on, which are usually reused and edited, under the circumstances where the content cannot be freely distributed.

Under these circumstances, international standardization of ISO/IEC 21000 (MPEG-21) which aims for the circulation and management of various types of digital content is proceeding. In the MPEG-21, a language (DIDL: Digital Item Declaration Language) for expressing composite content formed by combination of several items is standardized. Further, a Rights Expression Language (REL) enabling a flexible license description is also standardized. United States Patent Application Publication No. US2003/0125976 proposes a supporting method for describing a license in the REL.

As the form of reusing content, quoted content is reused in many cases. Quoting can be made without permission of the original copyright holder, which is advantageous to the party of creating secondary content. Requirements for permitting the quoting are very severe and some of them are difficult to determine objectively.

In the reuse of digital content, quoting is not permitted or the quality/value of the quoted content is remarkably deteriorated. For example, in the case of static image, such countermeasures are adopted that it is made in black and white and that its size and resolution is limited into a degraded image that one cannot enjoy watching. These permissive conditions are generally described in a license as a Usage control. For creating secondary content by quoting several content, a technique for protecting the intention of the original copyright holder by making the secondary content take over these permissive conditions is proposed (for example, Japanese Patent Application Laid-Open No. 2002-176549).

However, when the quoted content in the secondary content takes over the license information, for example, with the condition of degrading the quality/value of the quoting content, repetitive quoting causes remarkable deterioration in the quality of the content, which prevents the sound creation and distribution of the secondary content.

Taking the above into consideration, the invention mainly aims to provide a digital content editing apparatus, a digital content editing method, and a digital content editing program which can assure the sound secondary content use by eliminating the excessive constraint on a quoted content which is composite or single content.

### SUMMARY OF THE INVENTION

According to one aspect of the present invention, a digital content editing apparatus includes a reuse license processor configured to obtain from license information of content, rights expression of reuse operation including such consumable quoting conditions that does not make quoted content take over the license information. The quoted content is content created through quoting from an original content which is a composite or single content having the license information with the rights expression of reuse operation defined. The apparatus also includes an operational instruction creating unit configured to create an operational instruction for reusing the content according to the rights expression of reuse operation; a material reusing unit configured to reuse the content according to the operational instruction; a license information creating unit configured to create license information with the consumable quoting conditions deleted from the license information of the quoting content, as the license information of the quoted content; and an edit unit configured to edit the content.

According to another aspect of the present invention, a digital content editing method includes obtaining from license information of content, rights expression of reuse operation including such consumable quoting conditions that does not make quoted content take over the license information, the quoted content being content created through quoting from an original content which is a composite or single content having the license information with the rights expression of reuse operation defined; creating an operational instruction for reusing the content according to the rights expression of reuse operation; reusing the content according to the operational instruction; creating license information with the consumable quoting conditions deleted from the license information of the quoting content, as the license information of the quoted content; and editing the content.

According to still another aspect of the present invention, a computer program product has a computer readable medium including programmed instructions for executing a digital content editing processing. The instructions, when executed by a computer, cause the computer to perform obtaining from license information of content, rights expression of reuse operation including such consumable quoting conditions that does not make quoted content take over the license information, the quoted content being content created through quoting from an original content which is a composite or single content having the license information with the rights expression of reuse operation defined; creating an operational instruction for reusing the content according to the rights expression of reuse operation; reusing the content according to the operational instruction; creating license information with the consumable quoting conditions deleted from the license information of the quoting content, as the license information of the quoted content; and editing the content.

### BRIEF DESCRIPTION OF THE DRAWINGS

FIG. 1 is a block diagram of a digital content editing apparatus according to an embodiment of the invention;

FIG. 2 shows an example of the definition of the content data described in the XML format defined by the DIDL of the MPEG-21;

FIG. 3 shows an example of the data structure of the license information described in the format conforming to the REL of the MPEG-21 and expanded for describing the consumable quoting conditions;

FIG. 4 shows an example of the data structure of an operation table;

FIGS. 5A and 5B show examples of the data structure of quotation attribute data;

FIG. 6 is a flow chart showing the outline of the flow of the whole content editing processing according to the embodiment;

FIG. 7 is a flow chart showing the flow of the whole original content using processing in the digital content editing apparatus according to the embodiment;

FIG. 8 is a flow chart showing the flow of the whole reuse license processing in the digital content editing apparatus according to the embodiment;

FIG. 9 is a flow chart showing the outline of the flow of the whole operational instruction creating processing in the digital content editing apparatus according to the embodiment;

FIG. 10 is a flow chart showing the flow of the whole quoting conditions checking processing in the digital content editing apparatus according to the embodiment;

FIG. 11 is a flow chart showing the flow of the whole reuse processing in the digital content editing apparatus according to the embodiment;

FIG. 12 is a flow chart showing the flow of the whole default license creating processing in the digital content editing apparatus according to the embodiment;

FIG. 13 is a schematic view showing an example of the a content reuse screen;

FIG. 14 is a schematic view showing an example of the quoted content data newly created through quoting, described in the XML format;

FIG. 15 is a schematic view showing an example of the default license information;

FIG. 16 is a schematic view showing an example of the content data described in the XML format; and

FIG. 17 is an explanatory view showing an example of the content reuse performed according to the reuse processing.

### DETAILED DESCRIPTION OF THE INVENTION

Preferred embodiments of a digital content editing apparatus, a digital content editing method, and a digital content editing program according to the invention will be described in detail below with reference to the accompanying drawings.

A digital content editing apparatus according to an embodiment is to create license information having no consumable quoting conditions reflected as the license information for quoted content when quoting the content having the consumable quoting conditions. Further, it is to request to designate or newly create referring content for quotation and to permit the quoting only when there exists the referring content.

Here, the referring content means content which refers to quoted content in the secondary content. The consumable quoting conditions means such quoting conditions that the quoted content does not take over the license information of the quoting content which can be composite or single content. The material content can be composite or single content.

In reuse of content, the digital content editing apparatus according to the embodiment has a function of obtaining constraint indicating conditions about the reuse of some content among a plurality of contents and reusing the content so as to satisfy the obtained constraint. As the constraint, for example, a complementary constraint indicating that a plurality of contents are always reused at once and an exclusive constraint for prohibiting the simultaneous use of the content can be specified. Thus, the author's original intention of the composite content consisting of several contents can be protected.

In the embodiment, the use of the existing content is widely referred to as reuse and quoting is to indicate one mode of the reuse. Alternatively, there is the case of referring to the mode other than quoting, of the mode of the reuse, as the reuse (reuse in a narrow sense).

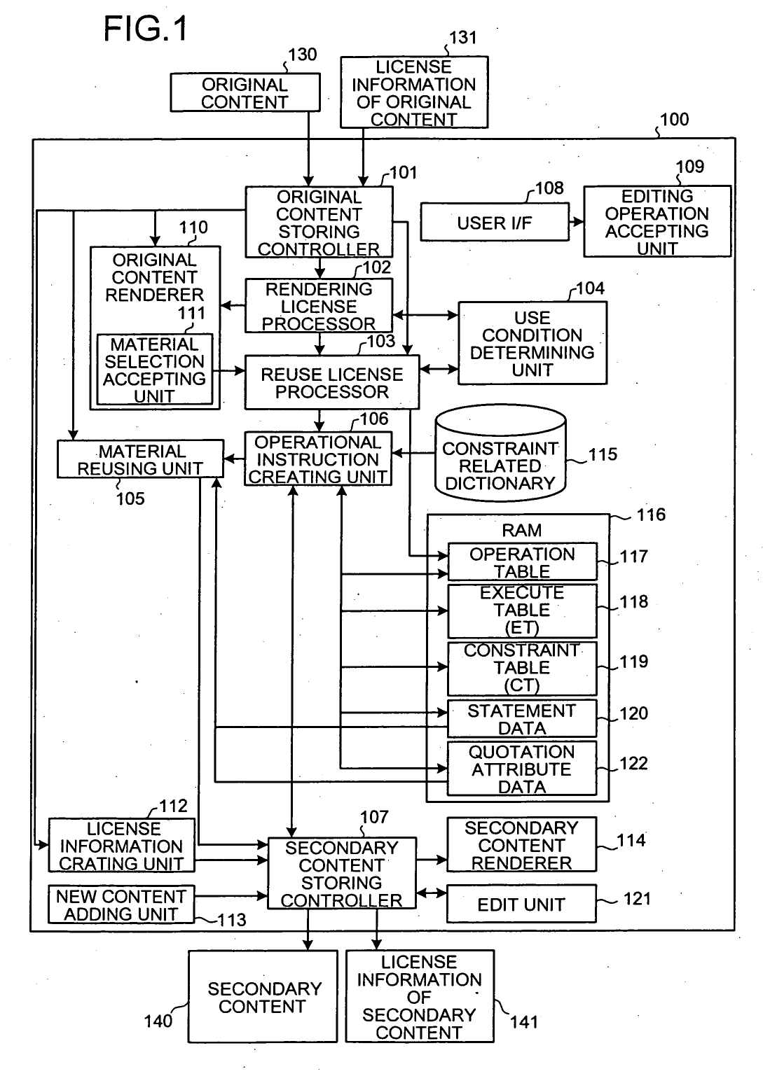

FIG. 1 is a block diagram of a digital content editing apparatus 100 according to the embodiment. As illustrated in FIG. 1, the digital content editing apparatus 100 includes an original content storing controller 101, a rendering license processor 102, a reuse license processor 103, a use condition determining unit 104, a material reusing unit 105, an operational instruction creating unit 106, a secondary content storing controller 107, a user I/F 108, an editing operation accepting unit 109, an original content renderer 110, a material selection accepting unit 111, a license information creating unit 112, a new content adding unit 113, a secondary content renderer 114, and an edit unit 121. The digital content editing apparatus 100 according to the embodiment stores a constraint related dictionary 115 onto a hard disk drive (HDD). Further, it stores an operation table 117, an execute table (ET) 118, a constraint table (CT) 119, statement data 120, and quotation attribute data 122 onto a RAM (random access memory) 116.

Here, the original content means the source content for reuse, and a single content or a composite content consisting of a plurality of content items can be the original content. The material content means some content selected from the whole content forming the original content as a material for reuse. The new content means content newly created regardless of the existing content. The secondary content means content created based on the original content, and the content with new content added to one or a plurality of material content depending on necessity can be the secondary content. The constraint may be described as the extension of the “Condition” element of the MPEG-21 REL.

In reusing content in the quoting mode, the secondary content created through conversion according to the quoting conditions such as constraint of size and requisition of copyright information is referred to as the quoted content. The above referring content means material content or new content to which the quoted content is used, and the whole content with the quoted content and the referring content corresponded also may be the secondary content.

The details of constraint will now be described. In the embodiment, constraint is defined in the format conforming to the REL of the MPEG-21 in an expanded way. Namely, a permissive operation called “adaptWithConstraint” is defined as the expansion of the “Right” (permissive operation) element in the REL of the MPEG-21 and the permissive operation is defined so as to designate one or both of a complementary constraint and an exclusive constraint. Thus, the permissive operation expanded so as to have a control on the permissive operation (“Right”) in the REL of the MPEG-21 corresponds to constraint.

The complementary relationship and the exclusive relationship are not always established in bi-direction and constraint is imposed only in one direction. When designating constraint in bi-direction, it is necessary to define the mutual complementary constraint or exclusive constraint.

The constraint may be represented in the XML format, tabular form, relational database form, semantic network form, and the like.

When reusing the main content including constraint, the complementary constraint is constraint for forcedly taking in constraint target content that is a target of the constraint at once. The complementary constraint is represented by a pair of constraint target content and the type of constraint. In the type of constraint, either the type of spatial constraint or the type of structural constraint is specified.

The spatial constraint types include: (1) above (the main content is positioned above the constraint target content); (2) below (the main content is positioned below the constraint target content); (3) rightSide (the main content is positioned on the right side of the constraint target content); (4) leftSide (the main content is positioned on the left side of the constraint target content); (5) backward (the main content is positioned on the backward of the constraint target content); (6) forward (the main content is positioned on the forward of the constraint target content); (7) anywhere (the main content is positioned anywhere); and (8) predefined stylesheet (the main content is positioned according to the separate data describing the position).

The structural constraint types include: (1) is Contained (the constraint target content is included in the main content as its component); and (2) isPartOf (the main content is included in the constraint target content as its component).

The constraint types are not restricted to the above-mentioned types but it may be further expanded. Depending on the type of content, it may be designed in that a specified constraint type cannot be defined. For example, when the both content being in the constraint relationship are audio content, the spatial concept is not their concern and so it may be designed so that the spatial constraint type cannot be set. In this case, it is possible to design to control the settable constraint type according to the quality of content, for example, MimeType.

The exclusive constraint is constraint for prohibiting the existence of constraint target content when reusing the main content. The exclusive constraint is represented by a pair of constraint target content and constraint type. In the constraint type, the exclusive constraint type (“exclusive”) may be specified.

Hereinafter, the outline of the functions of each unit forming the digital content editing apparatus 100 according to the embodiment will be described.

The original content storing controller 101 is to read original content 130 and license information 131 of the original content specified by a user from the user I/F 108 and to store the same onto a storing device such as RAM 116 within the digital content editing apparatus 100.

The rendering license processor 102 is to obtain rights expression about rendering included in the license information 131 of the original content and to perform the determination processing whether the original content 130 can be rendered or not, in cooperation with the use condition determining unit 104 described later.

The reuse license processor 103 is to obtain use conditions, consumable quoting conditions, and constraint, from the license information 131 of the content corresponding to the content ID received from the material selection accepting unit 111, to perform the determination processing whether the use conditions for reuse is satisfied or not and the determination processing of the constraint relationship, and to create the operation table 117.

The use condition determining unit 104 is to determine the use conditions described in the license information 131 of the content and to determine whether or not the content satisfies the use conditions for rendering or reuse.

Upon receipt of the operation table 117 created by the reuse license processor 103, the operational instruction creating unit 106 creates an operational instruction which satisfies the constraint stored in the received operation table 117, with reference to the information of the reusing content obtained from the secondary content storing controller 107 and the relationship between the constraints stored in the constraint related dictionary 115. The operational instructions created from the constraint are mainly stored in the statement data 120 and the operational instructions created from the consumable quoting conditions are mainly stored in the quotation attribute data 122.

The secondary content storing controller 107 stores the secondary content 140 under editing and the license information 141 of the secondary content onto a storing unit such as the RAM 116 and notifies the operational instruction creating unit 106 and the secondary content renderer 114 of the information about the secondary content 140 stored in the storing unit.

The material reusing unit 105 reads the necessary content from the storing device where the original content storing controller 101 has stored it, according to the operational instruction created by the operational instruction creating unit 106 and performs the reuse processing on the content being read out.

The user I/F 108 is a display and an input unit such as a keyboard and a mouse, which displays a screen (not illustrated) for selecting the material content and a content reuse screen and accepts an input operation on these screen.

The editing operation accepting unit 109 determines the type of the accepted editing operation, upon receipt of instructions for creation of a new content and editing operation by a user through the user I/F 108.

The material selection accepting unit 111 accepts the selection of the material content which the user reuses from the material content included in the original content 130. The original content renderer 110 renders the material content accepted by the material selection accepting unit 111.

The license information creating unit 112 takes over the license information of the quoting content and creates the default license information of the quoted content. When consumable quoting conditions are defined in the license information of the quoting content, the license information creating unit 112 creates license information having the consumable quoting conditions deleted, as the license information of the quoted content. The license information creating unit 112 performs the edit processing on the license information 141 of the secondary content including the quoted content and the quoting content.

The new content adding unit 113 adds a new content when the user instructs on the addition of the new content. The secondary content renderer 114 renders the secondary content under editing. The edit unit 121 is to edit the new content and the secondary content having the reused content added.

The constraint related dictionary 115 is a data file that stores the relationship between constraints, where constraint and its opposite constraint are defined. For example, the operation “below” which positions the main content below is stored as the opposite operation to the “above” which positions the main content above. The constraint related dictionary 115 is used to search for substantially the same constraints specified for the two contents and to eliminate the overlapped operation.

The RAM 116 is a random accessible memory, working as a storing unit for storing the operation table 117, the ET 118, the CT 119, the statement data 120, and the quotation attribute data 122.

The operation table 117 stores the operations permitted at a time of reusing each content that is the component of the composite content and the constraint type when there exists constraint. The details of the data structure of the operation table 117 will be described later.

The ET 118 is a table used for storing the result from extracting the execution condition of the content which is reused by itself without any constraint from the operation table 117, the result from merging the stored execution condition and the content of the CT 119, and the execution sequence created from the merged condition.

The ET 118 stores the order of execution at a time of reusing the content with the ID of the content first reused aligned from left to right. For example, when the content B is reused prior to the content A, the data “(B) (A)” is stored in the ET 118 and when the content D is reused prior to the content C, the data “(D) (C)” is stored there. Here, A, B, C, and D represent each content ID.

The CT 119 stores the result from extracting constraint from the operation table 117. When constraint is provided between two contents, the CT 119 stores the data with the constraint type described between the two content IDs. When no constraint is provided, the data describing only the content ID is stored. For example, when the content A is reused at a position below the content B, the data “(A below B)” is stored in the CT 119 and when the content B is reused on the right side of the content C, the data “(B rightSide C)” is stored there. When no constraint is imposed on the content D, the data “(D)” is stored in the CT 119.

The statement data 120 stores a statement for executing the reuse processing of the content, created through converting the execution sequence stored in the ET 118. After merging the ET 118 and the CT 119 hence to create an execution sequence, the statement data 120 stores the instructions for reuse in the order of reusing the content according to the created execution sequence. Specifically, it stores the sentences in which the content ID is converted into “exist (content ID)” as for the existing content, “new (content ID)” as for a newly created content, and “tmp (content ID)” as for the content having the “new” instruction just ahead although it has to be newly created, as statement. For example, when the execution sequence is “(A) (B below A)”, “(new (A)) (new (B) below tmp (A))” is stored in the statement data 120 as the statement.

The quotation attribute data 122 stores the quotation attributes, the information on a quoting method referred to in the case of reuse through quoting. The details of the data structure of the quotation attribute data 122 will be described later.

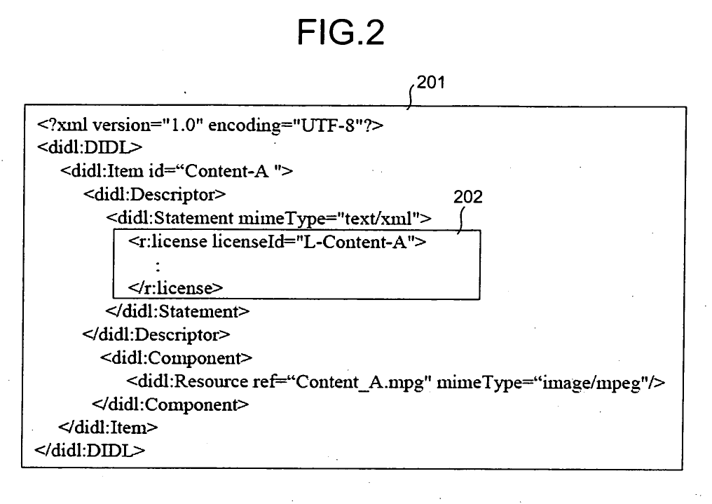

The details of the consumable quoting conditions will be described. FIG. 2 is an explanatory view showing an example of the definition of the content data described in the XML format defined by the DIDL of the MPEG-21. The data description area 201 defines the data of the content that is an advertising static image. The license information description area 202 specifies the license information including consumable quoting conditions of content.

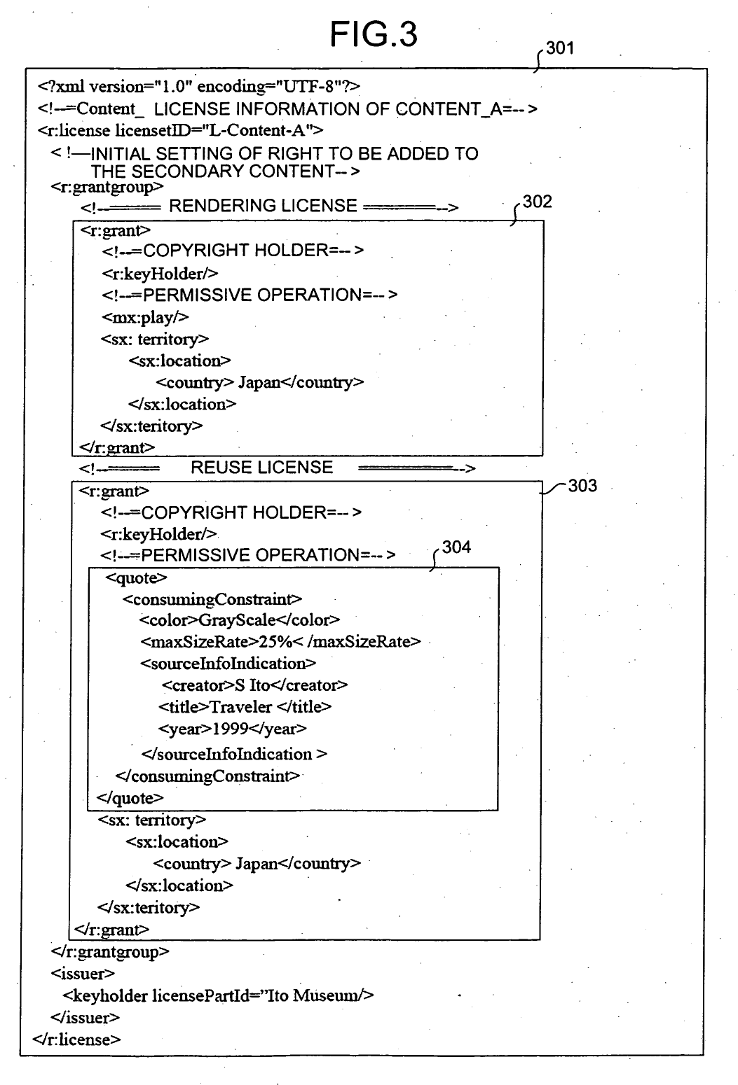

FIG. 3 shows an example of the data structure of the license information 131 of the content shown in FIG. 1 described in the format conforming to the REL of the MPEG-21 and expanded for describing the consumable quoting conditions. The description of all these rights expression (Grant) conforms to the REL of the MPEG-21, defining each element of a right holder (Principal), permissive operation (Right), and use conditions (Condition).

The license information 301 of FIG. 3 indicates the detailed descriptions of the license information description area 202 shown in FIG. 2. The license information 301 describes a rendering license 302 indicating the rights expression about rendering and a reuse license 303 indicating the rights expression about reuse. Further, the reuse license 303 describes consumable quoting conditions 304 (“consumingConstraint”) and this portion is the expanded part of the REL of the current MPEG-21.

The consumable quoting conditions 304 specifies conditions consumable at a point of quoting. For example, in the example shown in FIG. 3, conditions for converting and quoting is specified in such a way that the content is displayed in monochrome (color), its size is controlled to 25% maximum of the original size (maxSizeRate), and that author/title/date of creation is added as the information of quoting content (sourceInfoIndication).

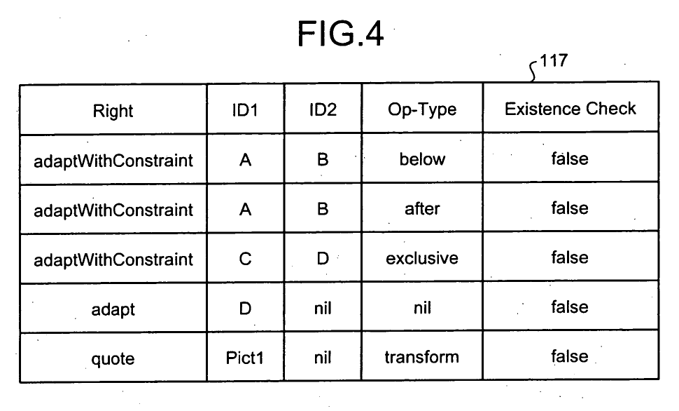

FIG. 4 shows an example of the data structure of the operation table 117. As illustrated in the example of FIG. 4, the operation table 117 stores the permissive operation (Right), the content ID (ID1) of the main content, the content ID (ID2) of the constraint target content, the constraint type (Op-Type), and a flag indicating whether the main content is being reused or not (ExistenceCheck).

The permissive operation is the information for designating an operation permitted at a point of using the content, where the content of the “Right” (permissive operation) element in the REL of the MPEG-21 are stored. In the digital content editing apparatus 100 according to the embodiment, “adapt” defined by the standard of the REL of the MPEG-21, or “quote” and “adaptWithConstraint” defined by expanding the REL of the MPEG-21 are set as the permissive operation.

The content ID of constraint target content is set only when “adaptWithConstraint” (permissive operation expanded so as to have constraint) is set as the permissive operation, and otherwise, “nil” is set. The constraint type is set only when the “adaptWithConstraint” or “quote” is set. When the permissive operation is the “adaptWithConstraint”, the value defined according to the type of constraint such as the spatial constraint and the structural constraint as mentioned above is set. When the permissive operation is the “quote”, “transform” is set when conversion processing such as the size control is necessary at the time of quoting, and otherwise, “nil” is set.

The flag indicating whether the main content is being reused or not is the information for use in the processing for disturbing creation of the operational instruction for the content under reusing and when it is being reused, “true” is set, while when it is not, “false” is set.

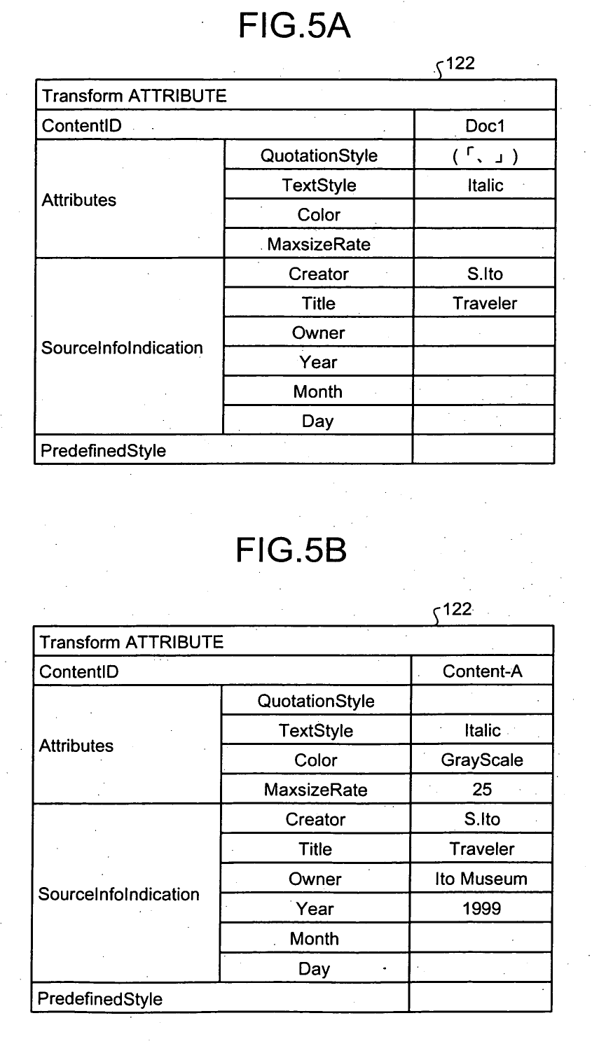

FIGS. 5A and 5B show examples of the data structure of the quotation attribute data 122. As illustrated in FIGS. 5A and 5B, the quotation attribute data 122 stores the content ID (ContentID) of the quoting content, the attributes (Attributes) for use in conversion, and the original copyright holder information (SourceInfoIndication) to be displayed at the time of quoting.

FIG. 5A shows an example of the quotation attributes for the content of text format such as article and FIG. 5B shows an example of the quotation attributes for the content of static image. Instead of the quotation attributes, a predetermined style may be used to convert the quoted content. In this case, the style define information (PredefinedStyle) stores the style specifying information.

In the embodiment, the type of quotation mark can be specified (QuotationStyle) and the text style (font, size, and the like) at the time of quoting can be specified (TextStyle), as the quotation attributes. These quotation attributes are suitable in the case of quoting the content of text format. Alternatively, original color display or monochrome display can be specified (Color) and the maximum size at the time of quoting can be specified (MaxsizeRate). These quotation attributes are suitable in the case of quoting the content of static image format. As the original copyright holder information to be displayed in case of quoting, the author (Creator), the name of work (Title), the owner of the original content (Owner), and the date of creation (Year/Month/Day) can be specified.

The quotation attributes are not restricted to the above but any attribute can be specified as far as it is the information on a quoting method referred to in reusing the content through quoting. For example, character code or resolution of image may be specified. In the case of quoting music/sound and moving picture, a time limit for permitting its rendering and reuse may be specified. As the original copyright holder information, bibliographic information including a reference, editor's name, translator's name and the material and the original size of a work may be specified. Further, the information may be converted multilingually and the original and the translation may be put down together.

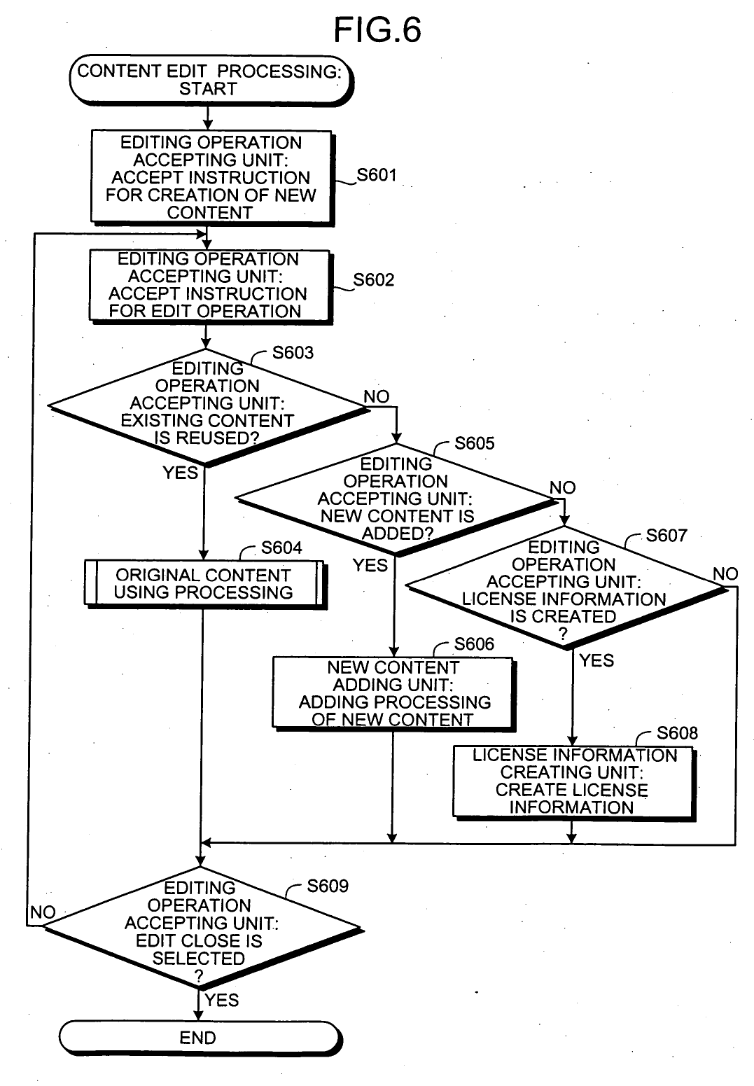

The content edit processing of the digital content editing apparatus 100 according to thus constituted embodiment will be described this time. FIG. 6 is a flow chart showing the flow of the whole content edit processing in the embodiment.

The editing operation accepting unit 109 accepts an instruction for creation of new content by the user (Step S601). The editing operation accepting unit 109 accepts an instruction for an editing operation (Step S602) and determines whether the accepted editing operation directs the reuse of the existing content (Step S603). When it does (Step S603: YES), the original content using processing is performed (Step S604). The details of the original content using processing will be described later.

When the accepted editing operation does not direct the reuse of the existing content (Step S603: NO), it is determined whether the accepted editing operation is an operation for adding a new content or not (Step S605). When it is (Step S605: YES), the addition processing of the new content is performed (Step S606). The addition processing of the new content may be realized by a function of the existing drawing tool, text editor, or video edit tool.

When the accepted editing operation is not the operation for adding the new content (Step S605: NO), it is determined whether the accepted editing operation is an operation for creating the license information or not (Step S607). When it is (Step S607: YES), the creating processing of the license information is performed (Step S608). The creating processing of the license information can be realized by expanding the edit function of constraint based on the technology of United States Patent Application Publication No. US2003/0125976.

When the accepted editing operation is not an operation for creating the license information (Step S607: NO), it is determined whether the edit close is selected by the user or not (Step S609). When the edit close is selected (Step S609: YES), the content edit processing is finished and when it is not selected (Step S609: NO), the instruction accepting processing of the editing operation is performed (Step S602).

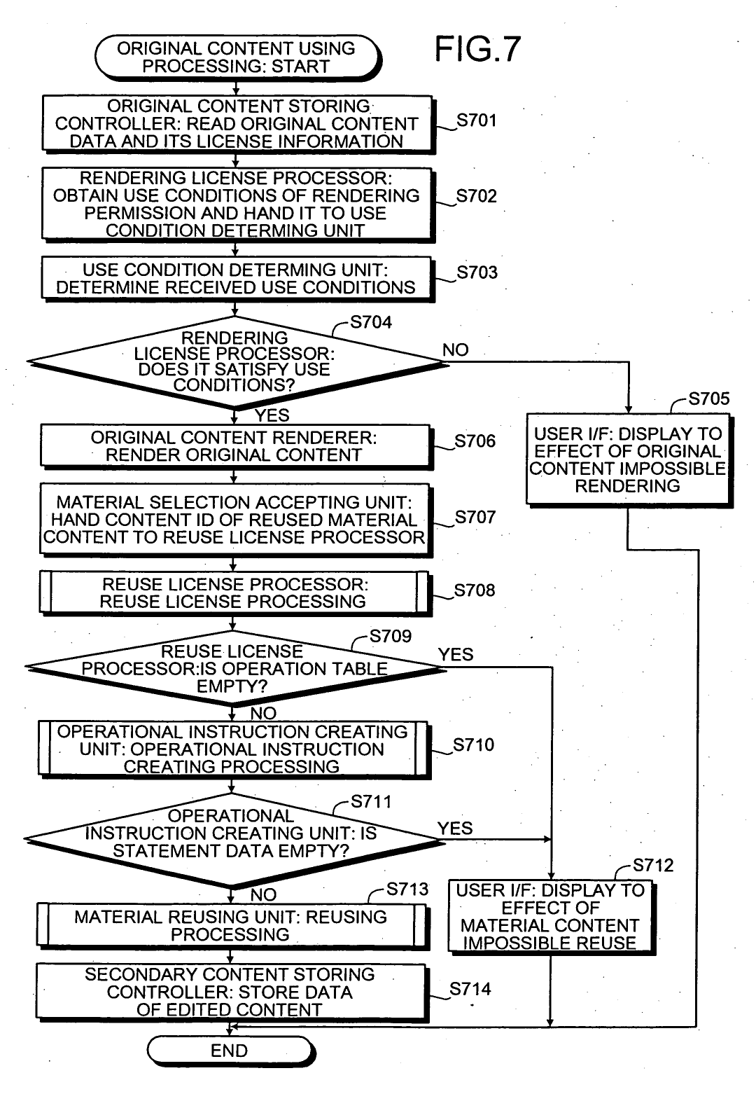

FIG. 7 is a flow chart showing the flow of the whole original content using processing in Step S604. At first, the original content storing controller 101 reads the content data of the original content 130 and its license information 131 which are designated by the user to reuse (Step S701). The original content 130 and the license information 131 may be integrated in the same file or they may be different files. The original content 130 may be read out from the storing medium such as the HDD existing locally, or the original content 130, existing in an external server, may be read out through downloading via a network.

The rendering license processor 102 obtains the use conditions included in the rendering license information of the license information and hands the obtained use conditions to the use condition determining unit 104 (Step S702). The use condition determining unit 104 determines whether the content satisfies the use conditions according to the obtained use conditions and returns the result to the rendering license processor 102 (Step S703). The use conditions including a validity period, billing method, price, available area, and the like. The use conditions may be determined internally by using the environmental information within the digital content editing apparatus 100 or it may be determined by using an external ASP through a network. Alternatively, the use conditions may be presented to the user in an interactive way such as inducing the user's agreement.

The rendering license processor 102 determines whether the content satisfies the use conditions or not according to the judgment result returned from the use condition determining unit 104 (Step S704). When it does not satisfy the use conditions (Step S704: NO), the original content 130 displays to the effect of impossible rendering (Step S705) and the original content using processing is finished. When it satisfies the use conditions (Step S704: YES), the original content renderer 110 renders the original content 130 (Step S706).

When the original content 130 is rendered, the material selection accepting unit 111 accepts the selection of the material content for reuse designated by the user, of the material content included in the rendered original content 130 and hands the content ID of the accepted material content to the reuse license processor 103 (Step S707).

The reuse license processor 103 analyzes the license information 131 of the content corresponding to the received content ID, performs the processing as for the license such as judgment of the use conditions for reuse and the settlement of the constraint, and creates the operation table 117 (Step S708). The details of the reuse license processing will be described later.

The reuse license processor 103 determines whether the created operation table 117 is empty or not (Step S709). When the operation table 117 is empty (Step S709: YES), the user I/F 108 displays a message to the effect of material content impossible reuse (Step S712). When the operation table 117 is not empty (Step S709: NO), the operational instruction creating unit 106 performs the operational instruction creating processing for creating an operational instruction which satisfies the constraint stored in the operation table 117 (Step S710). The details of the operational instruction creating processing will be described later.

After the operational instruction is created, the operational instruction creating unit 106 determines whether the statement data 120 is empty or not (Step S711). When the statement data 120 is empty (Step S711: YES), the user I/F 108 displays a message to the effect of material content impossible reuse (Step S712). When the statement data 120 is not empty (Step S711: NO), the material reusing unit 105 performs the reuse processing for reusing the material content according to the created operational instruction (Step S713). The details of the reuse processing will be described later.

After the content is reused, the secondary content storing controller 107 stores the data of the edited content (Step S714) and finishes the original content using processing.

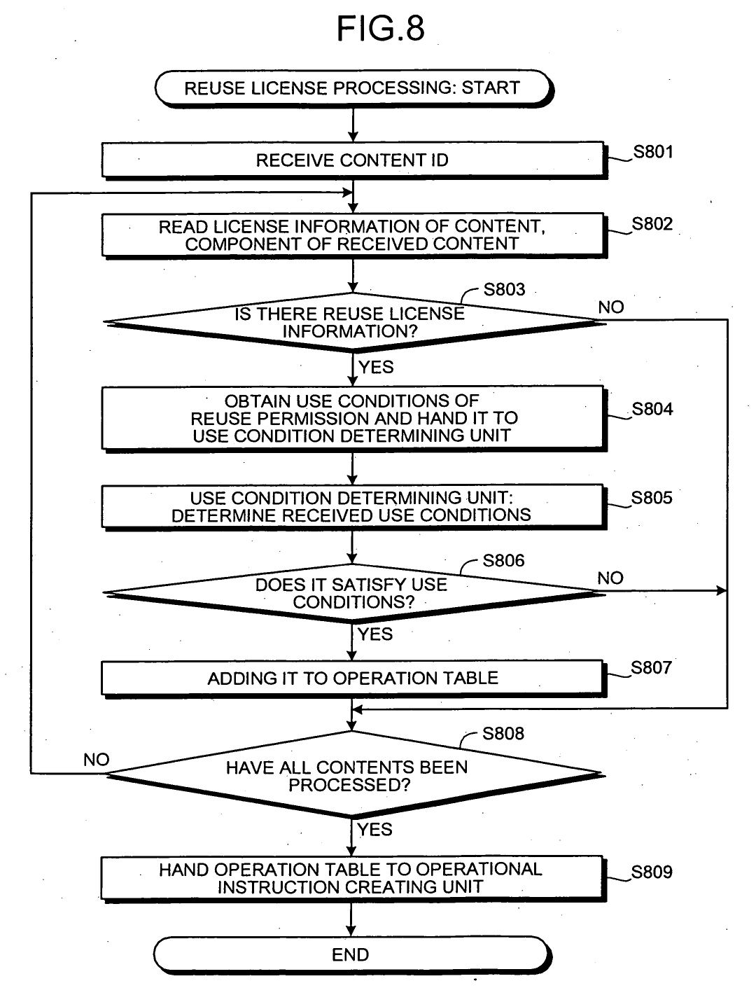

The details of the reuse license processing shown in Step S708 of FIG. 7 will be described. FIG. 8 is a flow chart showing the flow of the whole reuse license processing.

The reuse license processor 103 receives the content ID from the material selection accepting unit 111 (Step S801). Then, it performs the processing from Step S802 to Step S808 on all the contents, the components of the content corresponding to the received content IDs.

The reuse license processor 103 reads out the license information 131 of the component content (Step S802) and determines whether there exists the reuse license information (including the quote license information) or not (Step S803). When there does not (Step S803: NO), it performs the determination processing whether all the contents have been processed or not (Step S808). When there exists the reuse license information (Step S803: YES), it obtains the use conditions included in the reuse license information and hands the obtained use conditions to the use condition determining unit 104 (Step S804).

The use condition determining unit 104 determines, from the received use conditions, whether the content satisfies it or not and returns the result to the reuse license processor 103 (Step S805). The use conditions include the validity period, billing method, price, available area, and the like. The use conditions may be determined internally by using the environmental information within the digital content editing apparatus 100 or it may be determined by using an external ASP through a network. Alternatively, the use conditions may be presented to the user in an interactive way of inducing the user's agreement.

The reuse license processor 103 determines whether the content satisfies the use conditions or not, according to the judgment result returned from the use condition determining unit 104 (Step S806). When it does not satisfy the use conditions (Step S806: NO), it performs the judgment processing whether all the contents have been processed or not. When it satisfies the use conditions (Step S806: YES), the reuse license processor 103 adds the license information to the operation table 117 (Step S807).

After the data is added to the operation table 117, the reuse license processor 103 determines whether all the contents have been processed or not (Step S808), and when all the contents have not been processed (Step S808: NO), it performs the processing of reading the remaining component content (Step S802).

When all the contents have been processed (Step S808: YES), it hands the operation table 117 to the operational instruction creating unit 106 (Step S809) and finishes the reuse license processing.

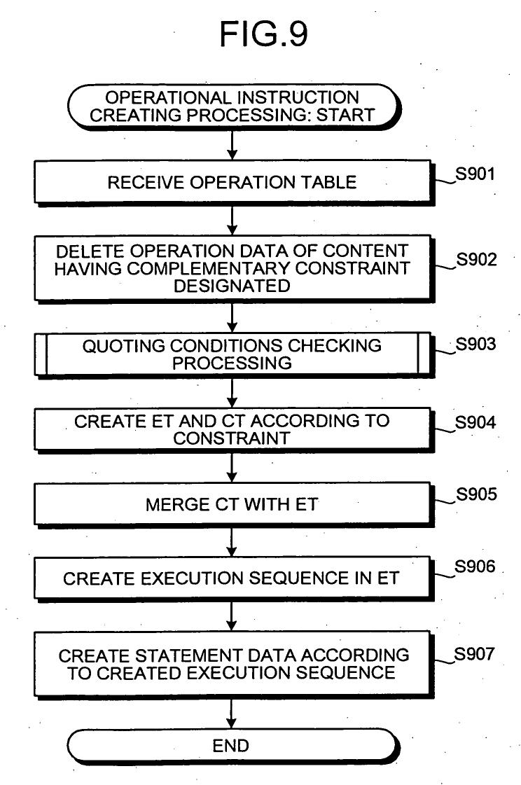

FIG. 9 is a flow chart showing the outline of the whole operational instruction creating processing shown in Step S710 of FIG. 7.

The operational instruction creating unit 106 receives the operation table 117 created by the reuse license processor 103 (Step S901). The operational instruction creating unit 106 deletes the operational data corresponding to the content having the exclusive constraint specified, from the operation table 117 including various operational data (Step S902). This is to prevent from simultaneously taking in a plurality of contents having the constraint on simultaneous use.

The operational instruction creating unit 106 performs the quoting conditions checking processing (Step S903). In the quoting conditions checking processing, it determines whether the quoting conditions are specified or not in the license information, as for each content stored in the operation table 117, and when it is specified, it creates the quotation attribute data 122 for use in converting the quoted content. The details of the quoting conditions checking processing will be described later.

The operational instruction creating unit 106 creates the ET 118 and the CT 119 according to constraint (Step S904). In the ET 118, it stores the content ID of the main content of the operational data. In the CT 119, for example, when the read operational data specifies the constraint of reusing so that the content A, the main content may satisfy the content B, the constraint target content and the constraint type Op, it adds the list “(A Op B)” there. Here, in the “Op”, the constraint type is set, such as (1) above, (2) below, (3) rightSide, (4) leftSide, (5) backward, (6) forward, (7) anywhere, and the like as mentioned above.

When the read operational data is, for example, an operation for reusing the content A only by itself without constraint, it adds the list “(A)” to the CT 119. When the read record is “(A above B)”, it obtains the operation “below” opposite to the operation “above” from the constraint related dictionary 115, and when the record “(B below A)” with the content IDs replaced with each other as for the opposite operation exists in the CT 119, the record is deleted from the CT 119. This is to eliminate the overlapped operation.

The operational instruction creating unit 106 performs the processing of merging the CT 119 with the ET 118 (Step S905). In the ET 118, only the content IDs of several contents to be used are stored, and this is because the order of creating each content has to be determined according to the constraints among the content stored in the CT 119.

For example, when the list “(A below B)” is stored in the CT 119 and the list “(B) (A)” is stored in the ET 118, the list “(B) (A)” in the ET 118 is replaced with the list “(B) (A below B)” and the list “(A below B)” is deleted from the CT 119. By merging thus, the execution order of creating the content B first and thereafter creating the content A below the content B can be determined.

For example, when the list “(A below B)” is stored in the CT 119 and the list “(C below A)” is stored in the ET 118, the list “(A below B)” is added prior to the list “(C below A)” of the ET 118, hence to be the list “(A below B) (C below A)”, and the list “(A below B)” is deleted from the CT 119. This is because the content A has to be created before the content C is positioned below the content A and the list “(A below B)” indicating an instruction for positioning the content A below the content B is first executed.

For example, when the list “(B below A) (A below C)” is stored in the ET 118, the head element “(A)” of the list “(A below C)” is inserted in before the list “(B below A) (A below C)”, hence to be the list “(A) (B below A) (A below C)”. This enables it to create the content A before the content B is positioned below the content A.

The operational instruction creating unit 106 performs the processing of creating an execution sequence in the ET 118 where the merge processing has been completed (Step S906). At this point, since a plurality of records are stored in the ET 118, it has to create one execution sequence considering the execution order between the records.

For example, when the record “(C) (B below C) (A below B)” and the record “(D) (C)” are stored in the ET 118, the final list “(C)” of the record “(D) (C)” is replaced with the record “(C) (B below C) (A below B)” and the record “(C) (B below C) (A below B)” is deleted, resulting in there remaining the record “(D)(C) (B below C) (A below B)” only.

For example, when the record “(B below C) (A below B)” and the record “(B below C) (C)” are stored in the ET 118, the head list “(B below C)” of the record “(B below C) (C)” is replaced with the record “(B below C) (A below B)” and the record “(B below C) (A below B)” is deleted, resulting in there remaining the record “(B below C) (A below B) (C)” only.

For example, when the record “(B below C) (A below B) (C)” is stored in the ET 118, the list “(B below C)” is replaced with “(B)” and the list “(C)” is replaced with the list “(C above B)”, hence to be “(B) (A below B) (C above B)” on the whole record. This is because although “B” has to be rendered below “C” according to the spatial constraint of “below” after the “C” is rendered, the rendering of the “C” is specified behind and therefore, the rendering order has to be changed and the operation has to be converted into the opposite operation.

The operational instruction creating unit 106 performs the processing of creating the statement data 120 in the ET 118 where the execution sequence creating processing has been completed (Step S907). For example, when the execution sequence is “(A) (B below A)”, “(new (A)) (new (B) below tmp (A))” is stored in the statement data 120 as statement.

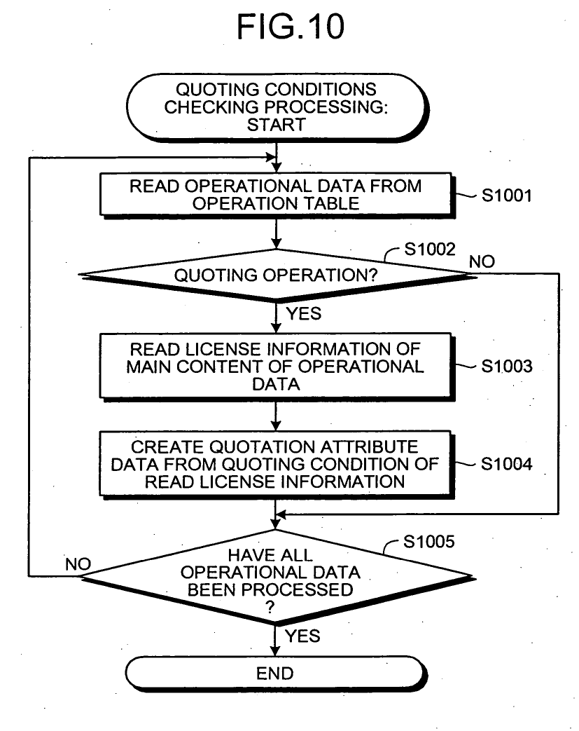

FIG. 10 is a flow chart showing the whole quoting conditions checking processing shown in Step S903 of FIG. 9. The quoting conditions checking processing is performed on all the quoting conditions described in the quoting operation (“quote”) of the reuse license, regardless of whether they are consumable quoting conditions or not.

The operational instruction creating unit 106 reads out the operational data from the operation table 117 (Step S1001). The operational instruction creating unit 106 determines whether the permissive operation (Right) of the read operational data is the quoting operation (“quote”) or not (Step S1002).

When it is not the quoting operation (Step S1002: NO), it performs the determination processing whether all the operational data has been processed or not (Step S1005). When it is the quoting operation (Step S1002: YES), the operational instruction creating unit 106 reads the license information of the main content (Step S1003).

The operational instruction creating unit 106 creates the quotation attribute data 122 from the consumable quoting conditions of the read license information (Step S1004). For example, when the consumable quoting conditions 304 as shown in FIG. 3 is specified, the operational instruction creating unit 106 creates the quotation attribute data 122 as shown in FIG. 5B.

The operational instruction creating unit 106 determines whether all the operational data has been processed or not (Step S1005), and when all the operational data has not been processed (Step S1005: NO), it reads out the next operational data and repeats the processing (Step S1001). When all the operational data has been processed (Step S1005: YES), it finishes the quoting conditions checking processing.

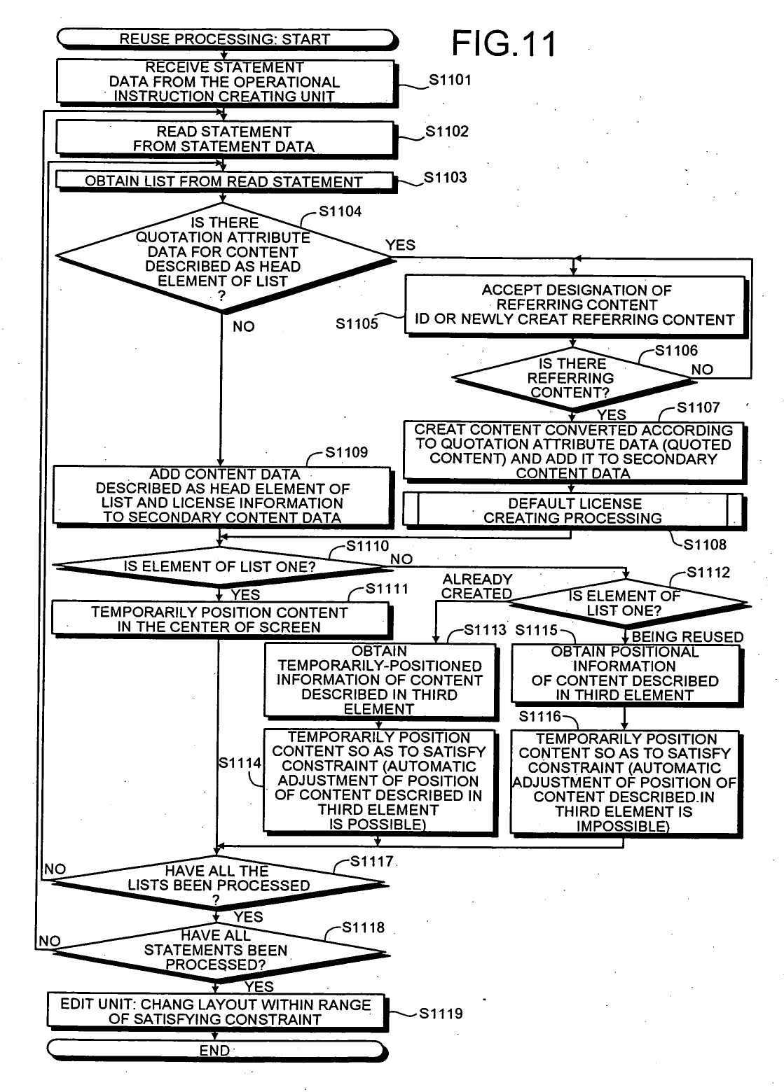

FIG. 11 is a flow chart showing the flow of the whole reuse processing shown in Step S713 of FIG. 7.

The material reusing unit 105 receives the statement data 120 created by the operational instruction creating unit 106 (Step S1101). The material reusing unit 105 reads out the statement from the received statement data 120 (Step S1102). Further, it obtains a list from the read statement (Step S1103).

The material reusing unit 105 determines whether there exists the quotation attribute data 122 corresponding to the content described as the head element of the list (Step S1104), and when there exists no such data (Step S1104: NO), it adds the data of the content described as the head element of the list and the license information to the secondary content data (Step S1109).

When there exists the quotation attribute data 122 (Step S1104: YES), the material reusing unit 105 accepts the designation of the content ID of the existing content, the referring content, or creates a referring content newly (Step S1105).

Specifically, when there already exists the referring content, the user may designate the same referring content rendered by the secondary content renderer 114 with mouse cursor through the user I/F 108, or he or she may search for it from a list of the content IDs including the content under editing by the secondary content storing controller 107 and present it, thereby selecting the referring content. When the quoting content has been previously selected, since there is no referring content to be selected, the edit unit 121 may induce the user to enter the referring content when he or she selects the quoting content, and the content ID of the input content may be handed to the material reusing unit 105.

The material reusing unit 105 determines whether there exists the referring content or not (Step S1106), and when there does not exist (Step S1106: NO), it returns to the designation accepting processing of the content ID or the new referring content creating processing, thereby repeating the processing (Step S1105).

The existence of the referring content is requisite as the important element of forming the quote, and this is important in the sense that the use of content promotes new creation and contributes to the development of culture. However, it is difficult to determine the master-servant relationship between the referring content and the quoting content objectively, and so far, the countermeasure to this element has not been examined. The embodiment solves the above problem by performing the above-mentioned determination processing and disturbing the quoting operation when there is no referring content.

The material reusing unit 105 creates content to be obtained by converting the content to be quoted (quoted content) according to the quotation attribute data 122 and adds the data of the created quoted content to the secondary content data (Step S1107).

The license information creating unit 112 performs the default license creating processing in order to create the default license information of the quoted content and the referring content (Step S1108). The details of the default license creating processing will be described later.

After the data of the content to be reused is added to the secondary content data in Step S1109 or after the default license creating processing is performed in Step S1108, it is determined whether the number of elements in the read list is one (Step S1110), and when the number is one (Step S1110: YES), the content corresponding to the content ID that is the element of the above list is temporarily positioned in the center of a screen (Step S1111). When it is not one (Step S1110: NO), the determination processing as for the type of the instruction of the third element is performed (Step S1112).

When the instruction of the third instruction is “already-created (tmp)” (Step S1112: already created), the temporary positional information of the content corresponding to the content ID described in the third element is obtained (Step S1113) and the content corresponding to the content ID described as the head element is temporarily positioned so as to satisfy the constraint described in the above list (Step S1114).

When the temporal position of the content corresponding to the content ID described in the third element is not proper to satisfy the constraint, it adjusts the position of the content corresponding to the content ID described in the third element so as to satisfy the constraint.

When the instruction of the third element is “being reused (exist)” (Step S1112: under reuse), the positional information of the content corresponding to the content ID described in the third element is obtained (Step S1115) and the content corresponding to the content ID described in the head element is temporarily positioned so as to satisfy the constraint described in the above list (Step S1116).

In this case, since the content corresponding to the content ID described in the third element is already being reused and its position has been defined, it cannot adjust the position of the content corresponding to the content ID described in the third element.

The material reusing unit 105 determines whether all the lists have been processed or not (Step S1117), and when all the lists have not been processed (Step S1117: NO), it reads out the next list and repeats the processing (Step S1103). When all the lists have been processed (Step S1117: YES), it performs the determination processing whether all the statements have been processed or not.

The material reusing unit 105 determines whether all the statements have been processed or not (Step S1118), and when they have not been all processed (Step S1118: NO), it obtains the next statement and repeats the processing (Step S1102). When they have been all processed (Step S1118: YES), the edit unit 121 changes the layout within the range of satisfying the constraint between the content, according to a user's instruction of layout change (Step S1119), and the reuse processing is finished.

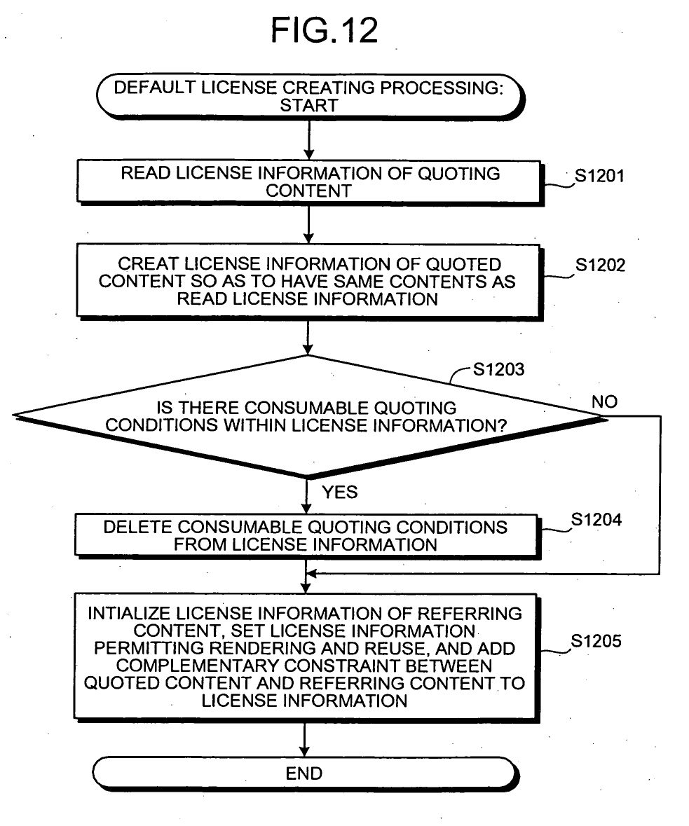

FIG. 12 is a flow chart showing the flow of the whole default license creating processing shown in Step S1108 of FIG. 11.

The license information creating unit 112 reads the license information of the quoting content (Step S1201). The license information creating unit 112 creates the same license information of the quoted content as the license information being read (Step S1202). This processing can be realized by adopting the method of making the quoted content take over the license information of the quoting content, described in Japanese Patent Application Laid-Open No. 2002-176549.

The license information creating unit 112 determines whether there exists consumable quoting conditions (“consumingConstraint”) within the created license information (Step S1203), and when there exists (Step S1203: YES), it deletes the consumable quoting conditions from the license information (Step S1204). Thus, even when the quote is repeated, the quoting conditions described in the consumable quoting conditions will not be repeatedly taken over, thereby preventing the deterioration in the quality of the content and contributing the sound secondary content creation and distribution.

The license information creating unit 112 initializes the license information of the referring content (Step S1205). Specifically, it sets the license information which permits the rendering and reuse. Further, it adds the complementary constraint between the quoted content and the referring content to the set permissive operation of the rendering and reuse. Since it is essential only that the quoted content and the referring content may be used simultaneously regardless of their positional relationship, “anywhere” is specified as the complementary constraint.

This can set the license information that permits the further reuse of the referring content always together with the simultaneous use of the quoted content. Since the license information being set here is the default license information, thereafter the user can add and change the license information (Step S608).

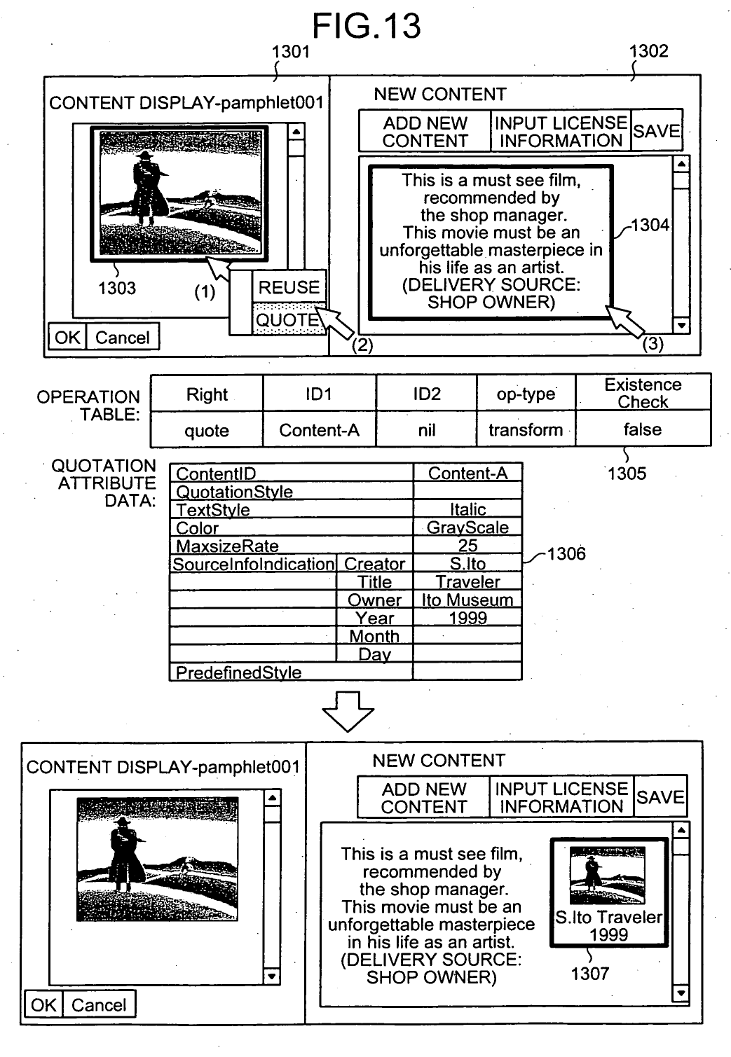

FIG. 13 to FIG. 17 are explanatory views each showing an example of the reuse of content performed according to the above reuse processing, in the digital content editing apparatus 100 according to the embodiment.

FIG. 13 is a schematic view showing an example of the content of the content reuse screen. The content reuse screen includes an original content display area 1301 for displaying the original content 130 and an edit area 1302 for adding new content or reusing and quoting the material content.

As illustrated in FIG. 13, when quoting the content, the user selects the original content 1303 of the static image and selects “quote” as the type of operation, of the “reuse” and “quote”. The “reuse” in FIG. 13 means the form of reusing the content in any other form excepting quoting (reuse in a narrow sense), differently from the reuse in the broad sense.

Next, the user designates the content 1304 of the text format as the referring content. Thus, the operation table 1305 as shown in FIG. 13 is created (Step S708) and the quotation attribute data 1306 is created (Step S1004). Further, the content 1307 obtained from the quoting of the original content 1303 and the conversion according to the quotation attribute data 1306 is created (Step S1107). The default license information about the content 1304 and the content 1307 is also created (Step S1202) and the complementary constraint is created between these two contents (Step S1205).

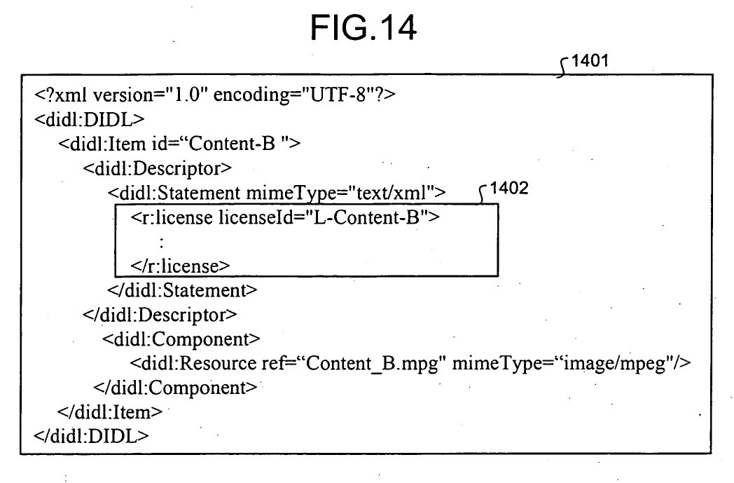

FIG. 14 is a schematic view showing one example of the quoted content data newly created through quoting, described in the XML format. FIG. 14 shows an example of the quoted content created by quoting the content shown in FIG. 2.

The whole content data is represented in a data description area 1401 and the license information is stored in a license information description area 1402. The content stored here is that one having been already converted reflecting the quoting conditions.

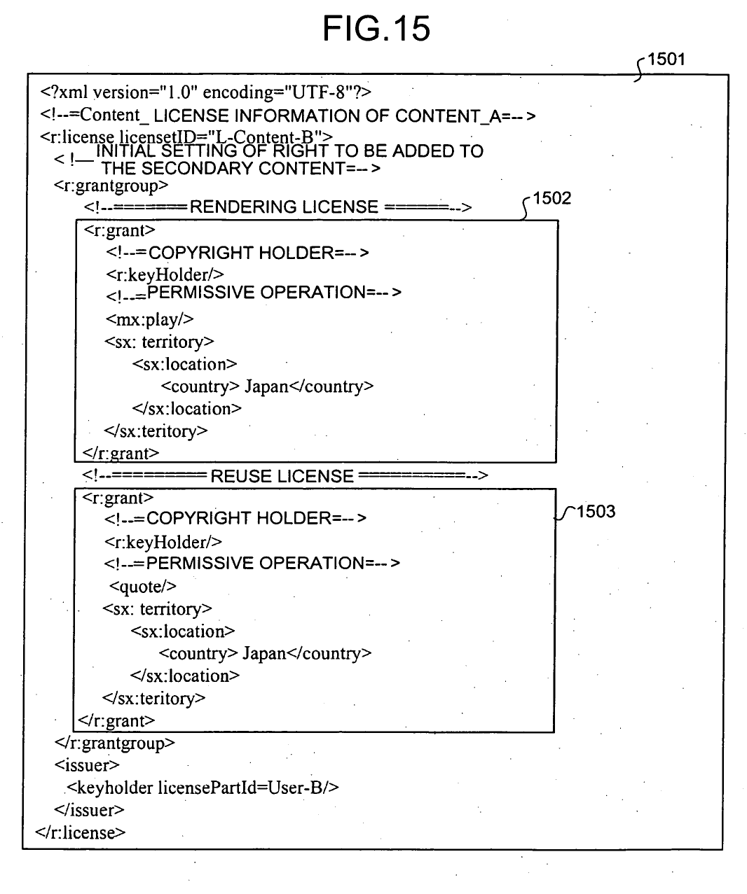

FIG. 15 is a schematic view showing one example of the default license information stored in the license information description area 1402 in FIG. 14. The license information 1501 includes a rendering license 1502 and a reuse license 1503. In the reuse license 1503, although a quoting operation (“Quote”) is described, conditions consumable through quoting as described in the consumable quoting conditions 304 of FIG. 3 is eliminated therefrom.

In the conventional technique, for example, when the quoting conditions as shown in FIG. 3 is specified, when the original content is first quoted, a quoted content is created with its size controlled to 25% and less and with the title and the date of creation displayed in the lower portion of the quoted content and at this time, the quoting conditions are not deleted form the license information. Therefore, when the created content is further quoted, a quoted content with its size further smaller and with the title and the creation data overlapped is created. Thus, according to the conventional technique, the quality of the content is deteriorated through repetition of quoting in some cases.

According to the embodiment, when consumable quoting conditions are obtained from license information, the license information is created without making the quoted content take over the consumable quoting conditions, thereby preventing the above defect.

A status variable such as a quote flag is attached to the consumable quoting conditions and it is taken over by the quoted content. Checking the above quote flag at the execution can prevent the quoting conditions from being adopted to the second quoting and later. In this method, however, a license including, needless to say, a status variable and nonsense conditions that will never be executed is circulated, with a large increase in data wastefully. Further, this brings a lot of load to the checking processing at a quoting. Therefore, the invention is considered to be superior in the performance.

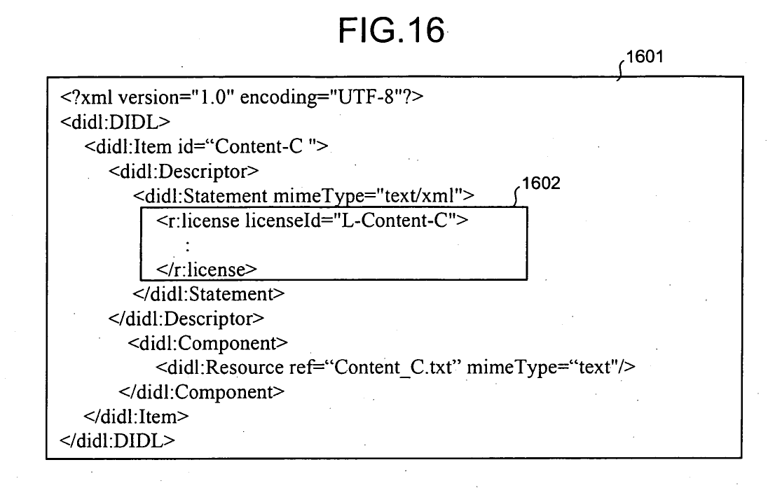

FIG. 16 is a schematic view showing one example of the content data created by the user in the XML format as the referring content. The whole content date is represented in a data description area 1601 and the license information is stored in a license information description area 1602.

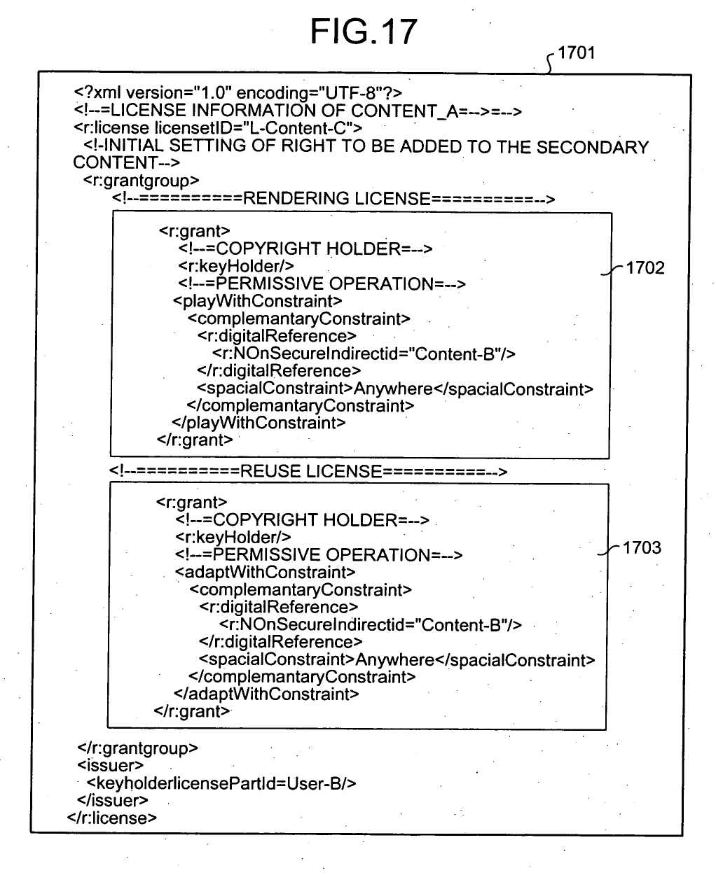

FIG. 17 is a schematic view showing one example of the default license information stored in the license information description area 1602 in FIG. 15. The license information 1701 includes a rendering license 1702 and a reuse license 1703. In the rendering license 1702 and the reuse license 1703, the complementary constraint at the reuse is added, and when the referring content is rendered or reused, also the quoted content newly created through quoting is necessarily rendered and reused.

Thus, according to the digital content editing apparatus 100 of the embodiment, it is possible to create such license information that disturbs the content created through quoting from taking over the quoting conditions in the case of designating quoting conditions which should not be adopted in the repetitive quoting. Therefore, it can prevent from deterioration in quality of the content even in the case of repetitive quoting. When another content is quoted, when there is no referring content, it can set not to perform the quoting. Therefore, the invention can promote new creation by use of content and contribute to the development of culture.

The digital content editing apparatus 100 according to the embodiment comprises a controller such as a CPU, a storing device such as a ROM (Read Only Memory) and a RAM, an external storing device such as an HDD and a CD driver, a display, and an input device such as a keyboard and a mouse, which is the general hardware structure using a computer.

A digital content editing program executed by the digital content editing apparatus 100 according to the embodiment is a file in the installable format or executable format, which is provided with the program recorded into a computer-readable storing medium such as a CD-ROM, a flexible disk (FD), a CD-R, a DVD (digital versatile disk), and the like.

The digital content editing program executed by the digital content editing apparatus 100 according to the embodiment may be stored into a computer connected to a network such as the Internet and provided, downloaded through the network. The digital content editing program executed by the digital content editing apparatus according to the embodiment may be provided or distributed through a network such as the Internet.

The digital content editing program according to the embodiment may be provided, previously built in the ROM and the like.

The digital content editing program executed by the digital content editing apparatus 100 according to the embodiment is designed in modules including the above mentioned units (the original content storing controller, the rendering license processor, the reuse license processor, the reuse condition determining unit, the material reusing unit, the operational instruction creating unit, the secondary content storing controller, the editing operation accepting unit, the original content renderer, the material selection accepting unit, the license information creating unit, the new content adding unit, the secondary content renderer, and the edit unit). Concretely, the digital content editing program may be provided on a hardware structure in such a manner that a CPU (processor) reads out the digital content editing program from the above storing medium and runs the program, hence to load and create the above units into the main storing device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital content editing apparatus comprising:
a reuse license processor configured to obtain from license information of content, rights expression of reuse operation including such consumable quoting conditions that does not make quoted content take over the license information, the quoted content being content created through quoting from an original content which is a composite or single content having the license information with the rights expression of reuse operation defined;
an operational instruction creating unit configured to create an operational instruction for reusing the content according to the rights expression of reuse operation;
a material reusing unit configured to reuse the content according to the operational instruction;
a license information creating unit configured to create license information with the consumable quoting conditions deleted from the license information of the quoting content, as the license information of the quoted content; and
an edit unit configured to edit the content.

2. The digital content editing apparatus according to claim 1, wherein the material reusing unit accepts designation or new creation of a referring content where the quoted content is used, and does not reuse the content when no referring content is designated or newly created.

3. The digital content editing apparatus according to claim 2, wherein the license information creating unit creates the license information having a complementary constraint which indicates the master-servant relationship between the both contents when using the quoted content and the referring content, as license information of the referring content.

4. A digital content editing method comprising:
obtaining from license information of content, rights expression of reuse operation including such consumable quoting conditions that does not make quoted content take over the license information, the quoted content being content created through quoting from an original content which is a composite or single content having the license information with the rights expression of reuse operation defined;
creating an operational instruction for reusing the content according to the rights expression of reuse operation;
reusing the content according to the operational instruction;
creating license information with the consumable quoting conditions deleted from the license information of the quoting content, as the license information of the quoted content; and
editing the content.

5. A computer program product having a computer readable medium including programmed instructions for executing a digital content editing processing, wherein the instructions, when executed by a computer, cause the computer to perform:
obtaining from license information of content, rights expression of reuse operation including such consumable quoting conditions that does not make quoted content take over the license information, the quoted content being content created through quoting from an original content which is a composite or single content having the license information with the rights expression of reuse operation defined;
creating an operational instruction for reusing the content according to the rights expression of reuse operation;
reusing the content according to the operational instruction;
creating license information with the consumable quoting conditions deleted from the license information of the quoting content, as the license information of the quoted content; and
editing the content.

6. The computer program product according to claim 5, wherein upon reusing the content, designation or new creation of a referring content where the quoted content is used is accepted, and the content is not reused when no referring content is designated or newly created.

7. The computer program product according to claim 5, wherein upon creating the license information, the license information having a complementary constraint which indicates the master-servant relationship between the both contents when using the quoted content and the referring content is created as license information of the referring content.
